(19) United States
(12) Patent Application Publication
(10) Pub. No.: US 2010/0323214 A1
(43) Pub. Date: Dec. 23, 2010

(54) Rolled copper foil

(75) Inventors: Takemi Muroga, Tsuchiura (JP); Satoshi Seki, Tsuchiura (JP); Noboru Hagiwara, Tsuchiura (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 12/588,361

(22) Filed: Oct. 13, 2009

(30) Foreign Application Priority Data
Jun. 22, 2009 (JP) 2009-147250

(51) Int. Cl. B32B 15/01; C22C 9/00

(52) U.S. Cl. 428/606

(57) ABSTRACT

A rolled copper foil includes copper (Cu), an inevitable impurity, a first additive element that forms a solid solution in the copper, and a second additive element that is different from the first additive element, is contained in the copper, and forms a compound with the inevitable impurity.

The present application is based on Japanese patent application No. 2009-147250 filed on Jun. 22, 2009, the entire contents of which are incorporated herein by reference.

### BACKGROUND OF THE INVENTION

1. Field of the Invention

The present invention relates to a rolled copper foil. In particular, it relates to a rolled copper foil used in flexible printed circuit boards.

2. Description of the Related Art

Flexible printed circuit (FPC) boards are thin and have excellent flexibility, and therefore a high degree of freedom for electronic device packaging. For this, the FPC boards are used in circuits in bending portions of flip phones, movable portions of digital cameras, printer heads, etc., and movable portions of disc devices such as hard disk drives (HDDs), digital versatile discs (DVDs), compact discs (CDs), etc.

Conventionally, a rolled copper foil for a flexible printed circuit board is known that contains 100-500 mass ppm of oxygen, one or more of Ag, Au, Pd, Pt, Rh, Ir, Ru, and Os such that T ranges 100-400 where T=[Ag]+0.6[Au]+0.6[Pd]+0.4[Pt]+0.4[Rh]+0.3[Ir]+0.3[Ru]+0.3[Os] ([M]: mass ppm concentration of element M), and not more than 30 mass ppm in total of S, As, Sb, Bi, Se and Te; and is 5-50 μm thick; and has I/I₀>20 where I is the (200)-plane intensity obtained by X-ray diffraction of rolled surface after annealing at 200 degrees for 30 minutes, and I₀ is the (200)-plane intensity obtained by X-ray diffraction of fine copper powder; and has a semi-softening temperature of 120-150° C.; and has a tensile strength of not less than 300 N/mm² at room temperature (see JP-A-2002-167632, for example).

The rolled copper foil for a flexible printed circuit board disclosed by JP-A-2002-167632 formed as above exhibits excellent bending fatigue lifetime properties.

Also, a bend-resistant oxygen-free rolled copper foil is known that contains 10 to 50 ppm of one or plural elements selected from the group consisting of Nb, Ti, Ni, Zr, V, Mn and Ta; and is formed of oxygen-free copper containing not more than 50 ppm of an inevitable impurity such as oxygen and having a thickness of not more than 100 μm formed by final cold working at a degree of processing of not less than 90% (see JP-A-JP-A-4-56754, for example).

The rolled copper foil for a flexible printed circuit board disclosed by JP-A-4-56754 formed as above exhibits excellent bending fatigue lifetime properties.

Refer to JP-A-2002-167632 and JP-A-4-56754, for example.

However, the rolled copper foil for a flexible printed circuit board disclosed by JP-A-2002-167632 may, in a high temperature condition of various temperature conditions, cause excessive progression of recrystallization in the copper foil, and therefore deterioration of bending fatigue lifetime properties of the copper foil. Also, the rolled copper foil for a flexible printed circuit board disclosed by JP-A-2002-167632 may be broken due to fatigue by producing an oxide from oxygen contained in that copper foil, and therefore has the limits of enhancement in bending fatigue lifetime properties.

Also, the bend-resistant oxygen-free rolled copper foil disclosed by JP-A-4-56754 uses oxygen-free copper as parent material, which contains a softening temperature-decreasing element, and therefore enhances bending fatigue lifetime properties in a low temperature condition, but may in a high temperature condition cause excessive progression of recrystallization in the copper foil, and therefore deterioration of bending fatigue lifetime properties of the copper foil. Thus, both of the copper foils of JP-A-2002-167632 and JP-A-4-56754 are difficult to exhibit excellent bending fatigue lifetime properties after thermal treatment in a wide temperature condition from a low to high temperature condition.

### SUMMARY OF THE INVENTION

Accordingly, it is an object of the present invention to provide a rolled copper foil that exhibits excellent bending fatigue lifetime properties even after thermal treatment in a wide temperature range.

(1) According to one embodiment of the invention, a rolled copper foil comprises:

copper (Cu);

an inevitable impurity,

a first additive element that forms a solid solution in the copper; and

a second additive element that is different from the first additive element, is contained in the copper, and forms a compound with the inevitable impurity.

In the one embodiment, the following modifications and changes can be made.

(i) The rolled copper foil further comprises not more than 0.002 wt. % of oxygen.

(ii) The first additive element comprises not less than 0.005 wt. % and not more than 0.05 wt. % of silver (Ag).

(iii) The second additive element comprises not less than 0.001 wt. % and not more than 0.09 wt. % of boron (B).

(iv) The second additive element comprises one element selected from the group consisting of niobium (Nb), titanium (Ti), nickel (Ni), zirconium (Zr), vanadium (V), manganese (Mn), hafnium (Hf), tantalum (Ta), and calcium (Ca), and a content thereof is not less than 0.001 wt. % and not more than 0.09 wt. %.

(v) The second additive element comprises a plurality of elements selected from boron (B), niobium (Nb), titanium (Ti), nickel (Ni), zirconium (Zr), vanadium (V), manganese (Mn), hafnium (Hf), tantalum (Ta), and calcium (Ca), and a total content thereof is not less than 0.001 wt. % and not more than 0.09 wt. %.

(vi) The rolled copper foil is formed to be in a crystal grain orientation state in which, as a result obtained by pole figure measurement using X-ray diffraction taking rolled surface as a reference point, the ratio [a]/[b] of β-scanning average diffraction peak intensities [a] at α=90° and [b] at α=30° of the pole figure measurement of a {022}_{Cu} copper crystal plane is [a]/[b]≧3.

(vii) The rolled copper foil comprises a thickness of not more than 20 μm.

### POINTS OF THE INVENTION

According to one embodiment of the invention, a rolled copper foil has a rolled copper foil-softening temperature enhanced by a first additive element forming a solid solution in the copper, and reduced by a compound produced by reaction of a second additive element and an inevitable impurity. The rolled copper foil of the embodiment can therefore exhibit excellent bending fatigue lifetime properties in a wide temperature range, e.g., from a low temperature of substantially 150° C. (i.e., substantially the same as the softening temperature of tough pitch copper) to a high temperature of substantially 350° C. (e.g., substantially the same as the softening temperature of “the first additive element-containing oxygen-free copper” increased by adding only the first additive element). This allows thermal treatment in various conditions, e.g., in the CCL step, of the rolled copper foil in this embodiment.

### BRIEF DESCRIPTION OF THE DRAWINGS

The preferred embodiments according to the invention will be explained below referring to the drawings, wherein:

FIG. 1 is a schematic diagram showing an X-ray diffraction pole figure measuring method in an embodiment according to the invention;

FIG. 2 is a diagram showing the relationship between the α-axis scanning angle obtained in X-ray diffraction pole figure measurement and the average diffraction intensity obtained by β-axis scanning of a sample for each α value;

FIG. 3 is a diagram showing a process for producing a rolled copper foil in the embodiment according to the invention;

FIG. 4A is a diagram showing the relationship between the α-axis scanning angle obtained in X-ray diffraction pole figure measurement of rolled copper foil in Example 1 and the average diffraction intensity obtained by β-axis scanning of a sample for each α value;

FIG. 4B is a diagram showing the relationship between the α-axis scanning angle obtained in X-ray diffraction pole figure measurement of rolled copper foil in Example 2 and the average diffraction intensity obtained by β-axis scanning of a sample for each α value;

FIG. 4C is a diagram showing the relationship between the α-axis scanning angle obtained in X-ray diffraction pole figure measurement of rolled copper foil in Example 3 and the average diffraction intensity obtained by β-axis scanning of a sample for each α value;

FIG. 4D is a diagram showing the relationship between the α-axis scanning angle obtained in X-ray diffraction pole figure measurement of rolled copper foil in Example 4 and the average diffraction intensity obtained by β-axis scanning of a sample for each α value;

FIG. 4E is a diagram showing the relationship between the α-axis scanning angle obtained in X-ray diffraction pole figure measurement of rolled copper foil in Example 5 and the average diffraction intensity obtained by β-axis scanning of a sample for each α value;

FIG. 4F is a diagram showing the relationship between the α-axis scanning angle obtained in X-ray diffraction pole figure measurement of rolled copper foil in Example 6 and the average diffraction intensity obtained by β-axis scanning of a sample for each α value;

FIG. 5A is a diagram showing the relationship between the α-axis scanning angle obtained in X-ray diffraction pole figure measurement of rolled copper foil in Comparative example 1 and the average diffraction intensity obtained by β-axis scanning of a sample for each α value;

FIG. 5B is a diagram showing the relationship between the α-axis scanning angle obtained in X-ray diffraction pole figure measurement of rolled copper foil in Comparative example 2 and the average diffraction intensity obtained by β-axis scanning of a sample for each α value;

FIG. 5C is a diagram showing the relationship between the α-axis scanning angle obtained in X-ray diffraction pole figure measurement of rolled copper foil in Comparative example 3 and the average diffraction intensity obtained by β-axis scanning of a sample for each α value;

FIG. 5D is a diagram showing the relationship between the α-axis scanning angle obtained in X-ray diffraction pole figure measurement of rolled copper foil in Comparative example 4 and the average diffraction intensity obtained by β-axis scanning of a sample for each α value;

FIG. 5E is a diagram showing the relationship between the α-axis scanning angle obtained in X-ray diffraction pole figure measurement of rolled copper foil in Comparative example 5 and the average diffraction intensity obtained by β-axis scanning of a sample for each α value;

FIG. 5F is a diagram showing the relationship between the α-axis scanning angle obtained in X-ray diffraction pole figure measurement of rolled copper foil in Comparative example 6 and the average diffraction intensity obtained by β-axis scanning of a sample for each α value; and

FIG. 6 is a schematic diagram showing a bending fatigue lifetime (sliding bending) testing method.

### DETAILED DESCRIPTION OF THE PREFERRED EMBODIMENTS

### Summary of One Embodiment

A rolled copper foil in this embodiment contains copper (Cu), an inevitable impurity, a first additive element, which forms a solid solution in the copper, and a second additive element different from the first additive element, which is contained in the copper, and which forms a compound with the inevitable impurity.

Rolled Copper Foil

The rolled copper foil in the embodiment of the invention is a rolled copper foil used in flexible circuit members such as flexible printed circuit (FPC) boards. Specifically, the rolled copper foil in this embodiment comprises copper (Cu), an inevitable impurity, a first additive element, which forms a solid solution in the copper, and a second additive element different from the first additive element, which is contained in the copper. Here, the second additive element is an element which forms a compound with the inevitable impurity. As one example, the rolled copper foil in this embodiment is a rolled copper foil obtained after final cold rolling and before recrystallization annealing in a rolled copper foil-producing process, as will be explained later, and is formed to be not more than 50 μm thick, preferably not more than 20 μm thick for use for FPC boards, for example.

Copper

The rolled copper foil in this embodiment is formed by using e.g. an oxygen-free copper or oxygen-free copper-based copper material as parent material. Here, the “oxygen-free copper” in this embodiment is, e.g., an oxygen-free copper defined in JIS C1020, or not less than 99.96%-purity copper containing no copper oxide (I) [Cu₂O], and/or residual deoxidant. The oxygen content is not completely zero, but an oxygen content on the order of a few ppm (a few 10⁻⁴%) in the oxygen-free copper in this embodiment is not excluded. Accordingly, the rolled copper foil in this embodiment is formed to contain not more than 0.002 wt. % (i.e., not more than 20 ppm) of oxygen, as one example. It is preferred that the oxygen content is further decreased to inhibit oxide production in the rolled copper foil. The solid solution of inevitable impurities, such as sulfur (S), phosphor (P), etc., in the oxygen-free copper tends to increase the softening temperature of the oxygen-free copper. On the other hand, the compounds of inevitable impurities (e.g., S, P, etc.) produced by reaction with the specified additive element in the oxygen-free copper decrease the softening temperature of the oxygen-free copper.

First Additive Element

The first additive element in this embodiment uses an element which forms a solid solution in the copper to thereby deform the copper crystal lattice, to increase the softening temperature of the produced rolled copper foil higher than the softening temperature of the copper before the solid solution formation. For example, the first additive element in this embodiment may use silver (Ag). The amount of silver is contained in the rolled copper foil to increase the softening temperature of the produced rolled copper foil higher than the softening temperature of the rolled copper foil with no silver solid solution. For example, the amount of silver contained in the rolled copper foil is preferably not less than 0.005 wt. %, to inhibit a decrease in bending fatigue lifetime properties of the rolled copper foil produced by thermal treatment in a high-temperature condition (e.g., 350° C.×60 min thermal treatment). Also, the amount of silver contained in the rolled copper foil is preferably not more than 0.05 wt. % (i.e., not less than 50 ppm and not more than 500 ppm), to prevent the bending fatigue lifetime properties of the produced rolled copper foil from being not enhanced due to no softening, i.e., recrystallization by thermal treatment in a low-temperature condition (e.g., 150° C.×60 min thermal treatment).

Also, the first additive element may, instead of silver, use an element selected from the group consisting of tin (Sn), iron (Fe), cadmium (Cd), antimony (Sb), bismuth (Bi), and indium (In).

Second Additive Element

The second additive element in this embodiment uses an element which reacts with the inevitable impurity to produce a compound, to decrease the softening temperature of the produced rolled copper foil. For example, the second additive element uses boron (B). In this embodiment, the amount of boron contained in the rolled copper foil is preferably not less than 0.001 wt. % and not more than 0.09 wt. % (i.e., not less than 10 ppm and not more than 900 ppm).

The reason for the upper limit of the boron additive amount being set at 0.09 wt. % is that the maximum boron amount of forming a solid solution in the copper as parent material is 0.09 wt. % in rolled copper foil-producing facilities in this embodiment. Also, the reason for the lower limit of the boron additive amount being set at 0.001 wt. % is because of decreasing the softening temperature of the produced rolled copper foil to an appropriate temperature from the practical point of view.

Also, the second additive element may, instead of boron alone, use one element selected from the group consisting of niobium (Nb), titanium (Ti), nickel (Ni), zirconium (Zr), vanadium (V), manganese (Mn), hafnium (Hf), tantalum (Ta), and calcium (Ca). In this case, taking account of its effect on conductivity, it is preferred that the amount of the one element contained in the rolled copper foil is not less than 0.001 wt. % and not more than 0.09 wt. % (i.e., not less than 10 ppm and not more than 900 ppm), preferably not less than 0.001 wt. % and not more than 0.07 wt. % (i.e., not less than 10 ppm and not more than 700 ppm), more preferably not less than 0.001 wt. % and not more than 0.05 wt. % (i.e., not less than 10 ppm and not more than 500 ppm).

Further, the second additive element may, instead of boron alone, use plural elements or alloys selected from the group consisting of boron (B), niobium (Nb), titanium (Ti), nickel (Ni), zirconium (Zr), vanadium (V), manganese (Mn), hafnium (Hf), tantalum (Ta), and calcium (Ca). In this case, it is preferred that the total amount of the plural elements or alloys contained in the rolled copper foil is not less than 0.001 wt. % and not more than 0.09 wt. % (i.e., not less than 10 ppm and not more than 900 ppm).

Inventor's Findings on the First and Second Additive Elements

The rolled copper foil in this embodiment is formed by using an oxygen-free copper or oxygen-free copper-based copper material as parent material. Accordingly, the first additive element (e.g. silver) is caused to form a solid solution in that parent material, to thereby have the function of increasing the softening temperature of the parent material. On the other hand, the second additive element (e.g. boron) produces a compound with inevitable impurities, such as sulfur (S), phosphor (P), etc. Here, when S, P, etc. form a solid solution in the parent material, the softening temperature of the parent material increases, but S, P, etc. and the second additive element produce a compound, thereby making it possible to inhibit S, P, etc. from forming a solid solution in the parent material. This allows the softening temperature of the parent material to be inhibited from increasing. That is, the reason for the softening temperature of typical oxygen-free copper being high is because inevitable impurities S, P, etc. form a solid solution in the parent material.

The rolled copper foil in this embodiment contains, in the parent material of oxygen-free copper or oxygen-free copper-based copper, both of the first additive element, which has the function of increasing the softening temperature, and the second additive element, which has the opposite function to the function of the first additive element, i.e., the function of decreasing the softening temperature. At first glance, containing both of the first and second additive elements is thought to cause their functions to cancel each other out, but the inventor has found that the first and second additive elements perform a synergy function without their functions canceling each other out.

Specifically, at first glance, it is thought that even though the second additive element contained in the parent material decreases the softening temperature of the rolled copper foil, the first additive element present increases the softening temperature of the rolled copper foil, so that the softening temperature does not decrease, or the softening temperature increases dependent on the additive amount of the first additive element. However, according to the inventor's findings, as shown in Table 1 below, the coexistence of the first additive element within the specified amount range and the second additive element within the specified amount range allows the rolled copper foil to have substantially the same softening temperature property (i.e., the property of the softening temperature-decreasing degree being the substantially the same) as the rolled copper foil (Example 2 in Table 1) containing no first additive element, but only the second additive element. Table 1 shows the case of using oxygen-free copper as the parent material, silver as the first additive element, and boron as the second additive element.

TABLE 1

| | First | Second | |
|---|---|---|---|
| | additive | additive | |
| | element | element | |
| | (Ag) | (B) | |
| | content | content | Softening after thermal |
| | [ppm] | [ppm] | treatment 150° C. × 60 min |
| Embodiment | 150 | 350 | Softened (Full recrystallization) |
| Example 1 | 100 | 0 | Not softened (including |
| | | | semi-softened) |
| Example 2 | 0 | 350 | Softened (Full recrystallization) |
| Example 3 | 0 | 0 | Not softened (including |
| | | | semi-softened) |

Further, in the case of the rolled copper foil (Example 2 in Table 1) containing no first additive element, but only the second additive element, softening that rolled copper foil at a high temperature (e.g., on the order of 350° C.) decreases the bending fatigue lifetime of that rolled copper foil to half, compared to softening that rolled copper foil at a low temperature (e.g., on the order of 150° C.). However, in the case of the rolled copper foil in the embodiment containing both of the first and second additive elements, it is found that the bending fatigue lifetime of the rolled copper foil after high-temperature softening as well as low-temperature softening is not short compared to softening the rolled copper foil at the low temperature, and that it exhibits a good bending fatigue lifetime. Specifically, the inventor has found that the rolled copper foil containing both of the first and second additive elements exhibits an excellent bending fatigue lifetime in a wide temperature range from a low to high temperature. Although it is not clear why the rolled copper foil in the embodiment containing both of the first and second additive elements having the mutually opposite functions exhibits this property, it is considered to be because the energy produced when the first additive element forms a solid solution in the parent material, and the energy produced when the second additive element produces a compound with inevitable impurities are balanced optimally within the additive amount range in the embodiment.

In summary, when copper is added with no second additive element, but only the first additive element, e.g., silver (on the order of 100 ppm, as one example), the softening temperature of the copper added with silver is on the order of 200° C. to 210° C. The bending fatigue lifetime of the silver-added copper after thermal treatment at 300° C. or higher is worsen in comparison to the standard bending fatigue lifetime of the silver-added copper after thermal treatment on the order of 200° C.

Also, when copper is added with no first additive element, but only the second additive element, e.g., boron (on the order of 350 ppm, as one example), the softening temperature of the copper added with boron is on the order of 150° C. to 160° C. The bending fatigue lifetime of the boron-added copper after thermal treatment at 200° C. or higher is worsen in comparison to the standard bending fatigue lifetime of the boron-added copper after thermal treatment on the order of 150° C.

However, the inventor has found that the rolled copper foil containing the first additive element, silver (150 ppm, as one example), and the second additive element, boron (350 ppm, as one example) has a softening temperature on the order of 150° C. to 160° C., and that the bending fatigue lifetime of the rolled copper foil after thermal treatment at 200° C. or higher, 300° C. or higher, and 350° C. or higher is not worsen in comparison to the standard bending fatigue lifetime of the rolled copper foil after thermal treatment on the order of 150° C.

A similar synergy effect is also verified for rolled copper foil containing not less than 0.001 wt. % and not more than 0.09 wt. % (i.e., not less than 10 ppm and not more than 900 ppm) in total of one or plural elements selected from the group consisting of boron (B), niobium (Nb), titanium (Ti), nickel (Ni), zirconium (Zr), vanadium (V), manganese (Mn), hafnium (HO, tantalum (Ta), and calcium (Ca), and not less than 0.005 wt. % and not more than 0.05 wt. % (i.e., not less than 50 ppm and not more than 500 ppm) of silver.

X-Ray Diffraction Pole Figure Measurement

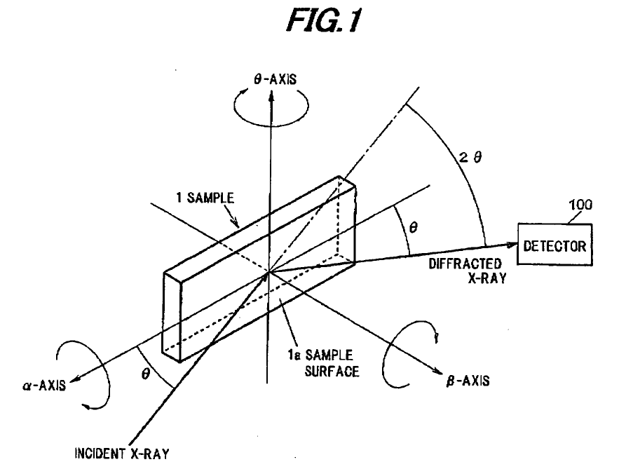

FIG. 1 schematically shows an X-ray diffraction pole figure measuring method in the embodiment according to the invention.

Specifically, schematically shown in FIG. 1 are the relationships between an incident X-ray, detector 100, sample 1, and scanning axes (e.g., α-, β-, and θ-axes), when measuring sample 1 of rolled copper foil using X-ray diffraction (herein, also referred to as “XRD”). Use of the measuring method as shown in FIG. 1 allows the evaluation of orientation states of crystalline grains of the rolled copper foil. The three θ-, α-, and β-scanning axes in FIG. 1 are called the “sample axis,” “tilting axis,” and the “in-plane rotational axis,” respectively. Also, the X-ray diffraction in this embodiment uses Cu Kα-rays.

X-Ray Diffraction Pole Figure Measuring Method

The X-ray diffraction (XRD) pole figure measuring method is explained. In the X-ray diffraction pole figure measuring method, an X-ray (see the incident X-ray in FIG. 1) is applied to sample 1, and the X-ray (see the diffracted X-ray in FIG. 1) diffracted at the sample 1 is detected by detector 100. Further, the sample 1 is disposed to be rotatable around the α-, β-, and θ-axis.

Specifically, specified diffraction plane {hkl}_{Cu} (h, k, l: Miller indices) of specified sample 1 (e.g., a sample formed of copper) is first looked at. At angle 2θ of scanning the {hkl}_{Cu} plane (i.e., fixed scanning angle 2θ of detector 100), and with α-axis scanning performed in angle steps, and for each α value, β-axis scanning (i.e., 0°-360° in-plane rotation around the β-axis) of the sample 1 is performed. This measuring method is called pole figure measurement. The pole figure measurement can three-dimensionally evaluate the angle of the {hkl}_{Cu} plane tilting from the normal to rolled surface. In the XRD pole figure measurement in this embodiment, the direction normal to sample surface 1a is defined as α=90°, to be taken as a reference point of measurement. Also, the pole figure measurement is divided into the reflection method (α=15°-90° and the transmission method (α=0°-15°), but the pole figure measurement in this embodiment uses the reflection method (α=15°-90°).

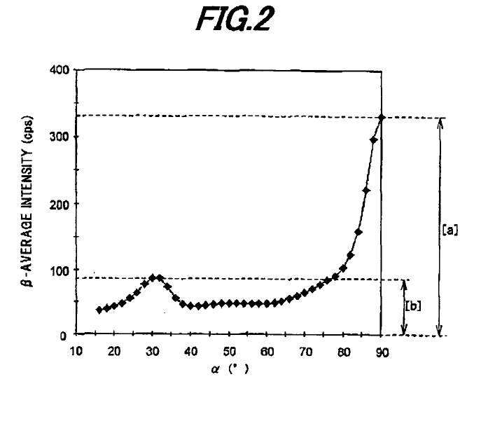

FIG. 2 shows one example of the relationship between the α-axis scanning angle obtained in X-ray diffraction pole figure measurement and the average diffraction intensity obtained by n-axis scanning of a sample for each α value.

In this embodiment, the ratio of α=90° β-average intensity [a] and α=30° β-average intensity [b] in the XRD pole figure measurement of a {022}_{Cu} plane of the copper crystal when taking the rolled surface of the rolled copper foil as a reference point is indicative of 3-dimensional orientation of the {022}_{Cu} plane to the rolled surface of the rolled copper foil prior to recrystallization annealing after final cold rolling. Also, the β-average diffraction intensity [a] at α=90° is obtained with the same principle as the 2θ/θ measurement principle explained later.

On the other hand, the β-average intensity [b] at α=30° is the diffraction peak intensity when sample 1 tilts at 60° relative to α=90°. The diffraction at α=30° shows that the {022}_{Cu} plane is geometrically at 60° to the {022}_{Cu} plane at α=90°, i.e., the copper crystal having that {022}_{Cu} plane as rolled surface is 3-dimensionally oriented at 60° to the {022}_{Cu} plane at α=90°. Thus, the larger the [a]/[b] value able to be computed by measuring β-average intensities [a] and [b] as shown in FIG. 2, the stronger the 3-dimensional orientation of the {022}_{Cu} plane of the copper crystal.

In this manner, controlling {022}_{Cu} plane orientation with information obtained by X-ray diffraction pole figure measurement differs significantly compared with controlling with information obtained by X-ray diffraction 2θ/θ measurement. In other words, the specified range of the {022}_{Cu} plane in this embodiment is totally different from the range specified by information obtained by X-ray diffraction 2θ/θ measurement. The details thereof are explained below.

2θ/θ Measuring Method

First is explained the X-ray diffraction 2θ/θ measurement principle. The 2θ/θ measurement refers to a measuring method by scanning sample 1 and detector 100 around the θ axis to the incident X-ray, through a sample 1-scanning angle of θ, and through a detector 100-scanning angle of 2θ. The sample 1 may be fixed, while the incident X-ray and detector 100 may be scanned around the θ axis (this depends on equipment configuration). The 2θ/θ measurement allows evaluation as to which crystalline plane of sample surface 1a (i.e., in this embodiment, rolled surface) of polycrystalline rolled copper foil is mainly present (herein, also referred to as “crystalline plane predominance”). However, although the crystalline plane predominance indicator is the diffraction peak intensity ratio, and can therefore determine whether or not the {022}_{Cu} plane is mainly present in the rolled surface, it fails to provide information on the occupancy (i.e., the absolute value of occupancy) of the {022}_{Cu} plane in the rolled surface. Further, although the X-ray diffraction 2θ/θ measurement allows one-axis orientation information, it fails to provide three-dimensional orientation (i.e., in-plane orientation) information. In short, the 2θ/θ measurement provides only qualitative information on the {022}_{Cu} plane. Even if the {022}_{Cu} plane is specified based on qualitative information obtained by the 2θ/θ measurement, at least three-dimensional orientation thereof cannot be controlled. The 2θ/θ measurement does not necessarily contribute to enhancement of the bending fatigue lifetime of the rolled copper foil.

Pole Figure Measuring Method

In the embodiment, on the other hand, information obtained by X-ray diffraction pole figure measurement allows quantitative control of three-dimensional orientation of the {022}_{Cu} plane, and can contribute to enhancement of the bending fatigue lifetime of the rolled copper foil. Specifically, the rolled copper foil in this embodiment is formed to be in a crystal grain orientation state in which, as a result obtained by pole figure measurement using X-ray diffraction taking rolled surface as a reference point, the ratio [a]/[b] of β-scanning average diffraction peak intensities [a] at α=90° and [b] at α=30° of the pole figure measurement of the {022}_{Cu} copper crystal plane is [a]/[b]≧3. That is, this embodiment can provide the rolled copper foil with strong three-dimensional orientation by causing the crystal orientation state prior to rolled copper foil softening to satisfy the ratio [a]/[b] of β-scanning average diffraction peak intensities [a] at α=90° and [b] at α=30° being not less than 3.

Rolled Copper Foil-Producing Method

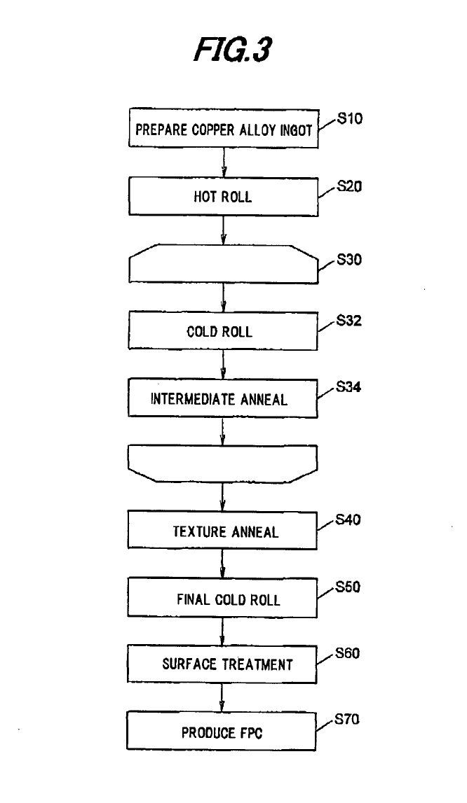

FIG. 3 shows one example of a process for producing a rolled copper foil in the embodiment according to the invention.

A copper alloy ingot is first prepared as raw material (ingot-preparing step: step 10, step is hereinafter referred to as “S”). For example, using not more than 2 ppm-oxygen-containing oxygen-free copper (e.g., JIS H3100, JIS C1020, or the like) as parent material, a copper alloy ingot containing a specified amount of a first additive element and a specified amount of a second additive element is prepared.

Subsequently, the ingot is hot-rolled to produce a plate material (hot-rolling step: S20). Following the hot-rolling step, the plate material is, repeatedly a specified number of times (S30), cold-rolled (cold-rolling step: S32) and intermediate-annealed (intermediate annealing step: S34). The intermediate annealing refers to relieving the work hardening of the cold-rolled plate material. This results in a copper strip called “texture” (herein, also referred to as “copper strip prior to final cold-rolling step”).

This is followed by specified annealing of that copper strip (texture-annealing step: S40). In the texture-annealing step, it is preferred to perform thermal treatment, such as substantially full annealing, capable of sufficiently relieving processing strains caused in each step prior to the texture annealing. Subsequently, the annealed texture is cold-rolled (final cold-rolling step (also called finish rolling step): S50). This results in the specified-thickness rolled copper foil in the embodiment.

This can be followed by placing the rolled copper foil in the embodiment into an FPC-producing process. In this case, surface treatment is first performed on the final-cold-rolled copper foil (surface treatment step: S60). Subsequently, the surface-treated rolled copper foil is put into FPC-producing process (FPC-producing step: S70). With the FPC-producing process, an FPC with the surface-treated rolled copper foil in the embodiment can be produced.

The FPC-producing process is outlined. The FPC-producing process includes, e.g., the steps of laminating the FPC copper foil and a polyimide resin base film (base material) to form a copper clad laminate (CCL) (CCL step); forming a circuit on the CCL by etching (circuit-forming step); and performing surface treatment on the circuit for circuit protection (surface treatment step). The CCL step may use 2 methods, one by stacking the copper foil and the base material via an adhesive, then curing the adhesive by thermal treatment, thereby forming a closely laminated structure (3-layer CCL), and the other by laminating the surface-treated copper foil directly to the base material without adhesive, then heating and pressurizing, thereby integrally forming a laminated structure (2-layer CCL).

Here, the FPC-producing process may use a cold-rolled copper foil (i.e., work-hardened rigid copper foil) from the point of view of facilitating production. This is because copper foil softened by annealing tends to be deformed (e.g., elongated, wrinkled, folded, etc.) when cutting that copper foil or stacking on the base material, and may cause a product defect.

On the other hand, the bending fatigue lifetime properties of copper foil are more remarkably enhanced when recrystallization-annealing the copper foil than when rolling the copper foil. Accordingly, in the above-mentioned thermal treatment for closely integrally laminating the copper foil and base material in the CCL step, it is preferred to employ the producing method including recrystallization-annealing of the copper foil. The thermal treatment conditions for recrystallization annealing may be varied according to contents of the CCL step, and as one example, the thermal treatment is performed at a temperature of not less than 150° C. and not more than 350° C. for not less than 1 min and not more than 120 min. Also, the recrystallization annealing may be performed in a separate step, rather than the CCL step. The thermal treatment within such a temperature condition range can result in the copper foil having recrystallized structure. Here, for the FPC, the bending fatigue lifetime of the polyimide resin base film is remarkably long compared to the bending fatigue lifetime of the copper foil. Accordingly, the bending fatigue lifetime of the entire FPC depends largely on the bending fatigue lifetime of the copper foil.

### Advantages of the Embodiment

Since the rolled copper foil in the embodiment according to the invention has a rolled copper foil-softening temperature enhanced by the first additive element forming a solid solution in the copper, and reduced by the compound produced by reaction of the second additive element and the inevitable impurity, it can exhibit excellent bending fatigue lifetime properties in a wide temperature range, e.g., from a low temperature of substantially 150° C. (i.e., substantially the same as the softening temperature of tough pitch copper) to a high temperature of substantially 350° C. (e.g., substantially the same as the softening temperature of “the first additive element-containing oxygen-free copper” increased by adding only the first additive element). This allows thermal treatment in various conditions, e.g., in the CCL step, of the rolled copper foil in this embodiment.

Also, since the rolled copper foil in this embodiment can exhibit excellent bending fatigue lifetime properties as mentioned above, the rolled copper foil can be used in application to flexible printed circuit boards, and other flexible circuits of conductive members. Further, the rolled copper foil in this embodiment can be applied to conductive members considered to have a certain correlation between no-load or non-fixed state vibration resistance and bending fatigue lifetime properties.

There are explained rolled copper foils in Examples 1-6 and comparative examples 1-6 produced, based on the embodiment.

### EXAMPLES

The rolled copper foils in examples 1-6 and comparative examples 1-6 all are produced with the same process, except varying the oxygen concentration in oxygen-free copper and the additive amounts of Ag and B. Table 2 shows the composition of each rolled copper foil. In Table 2, the amounts of Ag, B and O in the rolled copper foils in Examples 1-6 and comparative examples 1-6 are analysis values. In the rolled copper foils in Examples 1-6 and comparative examples 1-6, the maximum amount of B forming a solid solution in the Cu parent material is 0.09 wt. % (i.e., 900 ppm).

TABLE 2

| | Oxygen (ppm) | Ag (ppm) | B (ppm) |
|---|---|---|---|
| Example 1 | 19 | 490 | 900 |
| Example 2 | 5 | 50 | 890 |
| Example 3 | 12 | 300 | 12 |
| Example 4 | 5 | 100 | 30 |
| Example 5 | 2 | 150 | 300 |
| Example 6 | 8 | 300 | 250 |
| Comparative example 1 | 8 | 700 | 900 |
| Comparative example 2 | 17 | 30 | 900 |
| Comparative example 3 | 3 | 710 | 6 |
| Comparative example 4 | 5 | 30 | 7 |
| Comparative example 5 | 2 | 190 | 370 |
| Comparative example 6 | 8 | 300 | 250 |

Rolled Copper Foil Production

below is explained a method for producing the rolled copper foil in example 1 as a typical example. A main raw material using oxygen-free copper as parent material is first melted in a melting furnace, followed by addition of a specified amount of Ag (i.e., 490 ppm of Ag in Example 1) and a specified amount of B (i.e., 900 ppm of B in Example 1), to produce a 150 mm-thick, 500 mm-wide ingot (ingot-preparing step). Subsequently, with the rolled copper foil-producing method in the embodiment, the ingot is hot-rolled to produce a 10 mm-thick plate material (hot-rolling step). Following this, the plate material is repeatedly cold-rolled (cold-rolling step) and intermediate-annealed (intermediate annealing step) to produce a “texture.” The “texture” is annealed (texture-annealing step). In all of Examples 1-6 and comparative examples 1-6, the texture annealing is performed at approximately 650° C. for 1 minute.

Subsequently, the annealed texture is cold-rolled (final cold-rolling step). This results in the 0.012 mm-thick rolled copper foil in Example 1. The method for producing the rolled copper foil in Examples 2-6 and comparative examples 1-6 is the same as that of Example 1.

To cause the {022}_{Cu} plane after the final cold rolling to be in a state of [a]/[b]≧3, in the final cold rolling, combinations of conditions of forward tension, rolling speed (i.e., roller-rotating speed), roller diameter, etc. are regulated for each roll pass (i.e., in rolling per 1 pass). Specifically, the “tension component” is first set to be larger than the “compression component,” in the relation [(tension component)+(compression component)=2×(shear yield stress)] (for details of this formula, see Sosei Kako Gijutsu series 7 “ITA ATSUEN” p. 27, equation (3. 3), The Japan Society for Technology of Plasticity (JSPT), CORONA PUBLISHING CO., LTD.). Further, for each roll pass, rolling is controlled to balance the rolling speed and roller diameter conditions, i.e., to position the neutral point in contact surface of the roller and material during rolling, in the forward direction (i.e., moving direction) relative to ½ position of the contact surface in the contact surface-rolling direction. For details of the neutral point, see Sosei Kako Gijutsu series 7 “ITA ATSUEN” p. 14, p. 28, The Japan Society for Technology of Plasticity (JSPT), CORONA PUBLISHING CO., LTD. This causes the {022}_{Cu} plane after the final cold rolling to be in a state of [a]/[b]3.

X-Ray Pole Figure Measurement by XRD

The XRD evaluation of the rolled copper foils after the final cold rolling and before the recrystallization annealing is made as follows, using an X-ray diffractometer (model: Ultima-IV), Rigaku Corporation. Its anticathode (target) uses Cu, and the X-ray tube voltage and current are set at 40 kV and 40 mA, respectively. Also, the sample size used in XRD measurement is approximately 30 mm×approximately 30 mm.

The pole figure measurement conditions are as follows: the {022}_{Cu} plane diffraction intensity is measured using Schulz reflection, 0°-360° β-angle scanning (rotating) in the range of α=16°-90° (the direction normal to rolled surface is defined as α=90°, at the 2θ of approximately 74.15°, the 2θ value using the result of preliminary measurement for each sample.

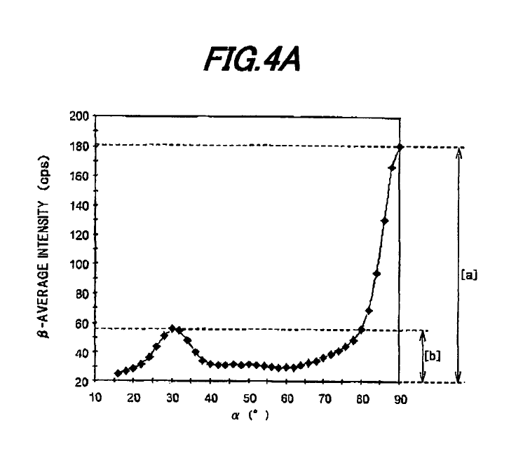

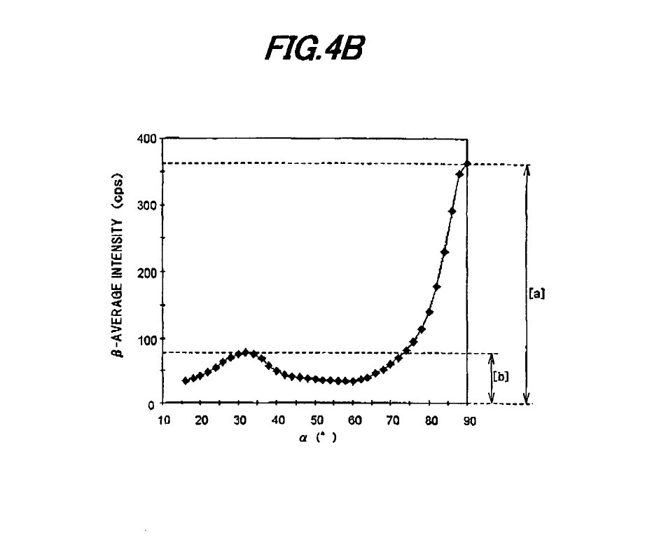

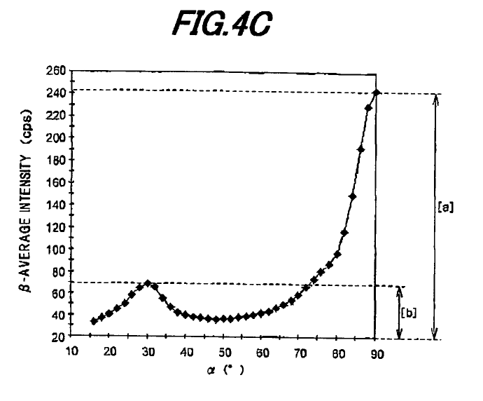

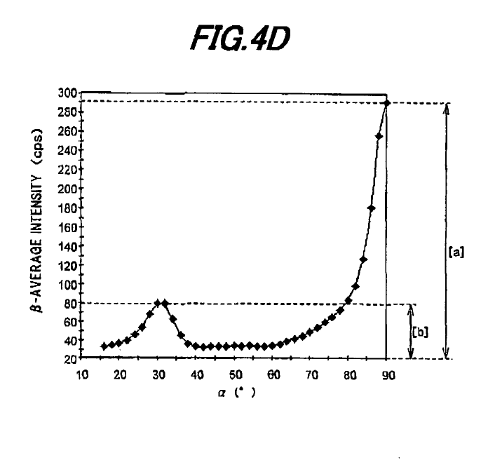

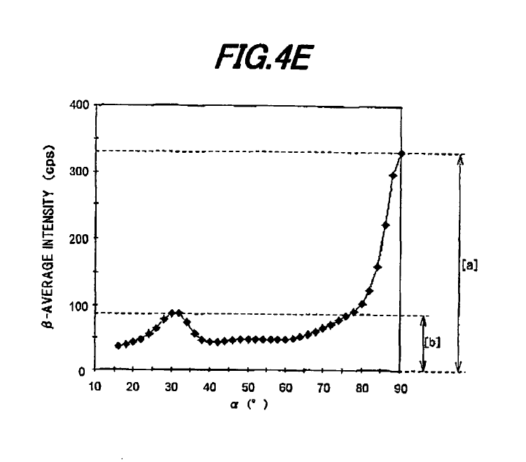

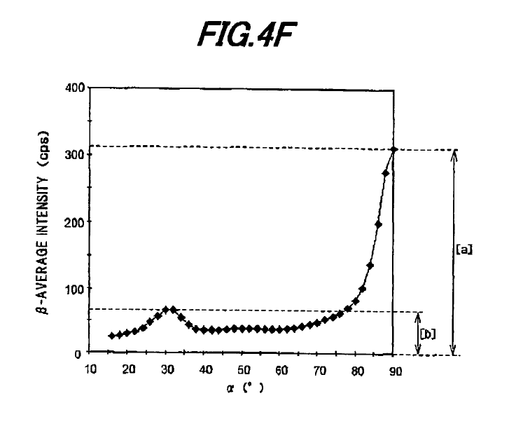

FIGS. 4A-4F each show the result of X-ray diffraction pole figure measurement of {022}_{Cu} plane of rolled copper foil after final cold rolling in Examples 1-6, respectively. Specifically, FIGS. 4A-4F each show the relationship between the α-axis scanning angle obtained in pole figure measurement of rolled copper foil in Examples 1-6 respectively, and the average diffraction intensity obtained by β-axis scanning of a sample for each α value.

As shown in Table 3 shown later, the [a]/[b] value is not less than 3 in all rolled copper foils in Examples 1-6.

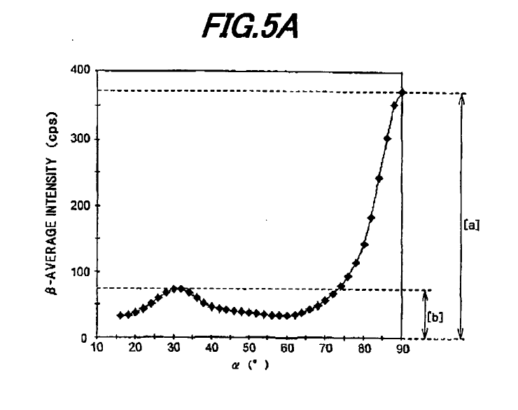

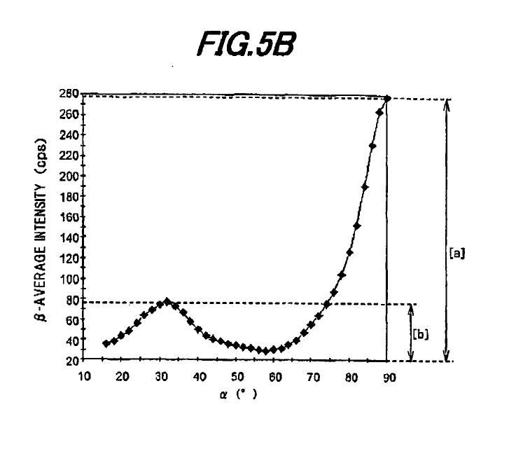

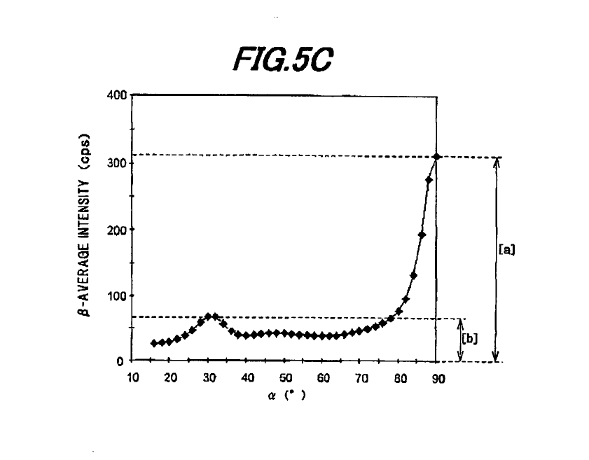

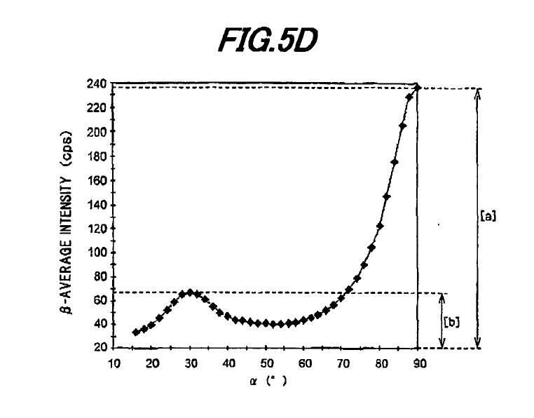

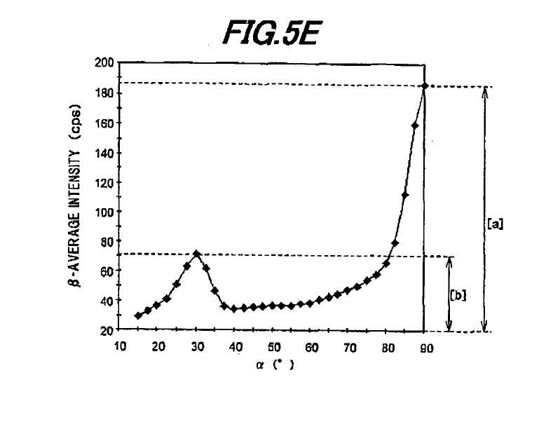

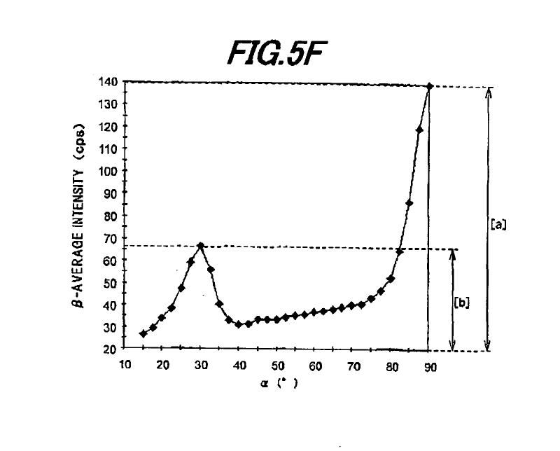

FIGS. 5A-5F each show the result of X-ray diffraction pole figure measurement of {022}_{Cu} plane of rolled copper foil after final cold rolling in comparative examples 1-6, respectively. Specifically, FIGS. 5A-5F each show the relationship between the α-axis scanning angle obtained in pole figure measurement of rolled copper foil in comparative examples 1-6 respectively, and the average diffraction intensity obtained by β-axis scanning of a sample for each α value.

As shown in Table 3 shown later, the [a]/[b] values of the rolled copper foils in comparative examples 1-4 are not less than 3. On the other hand, the [a]/[b] values of the rolled copper foils in comparative examples 5 and 6 are less than 3.

Bending Fatigue Lifetime Test

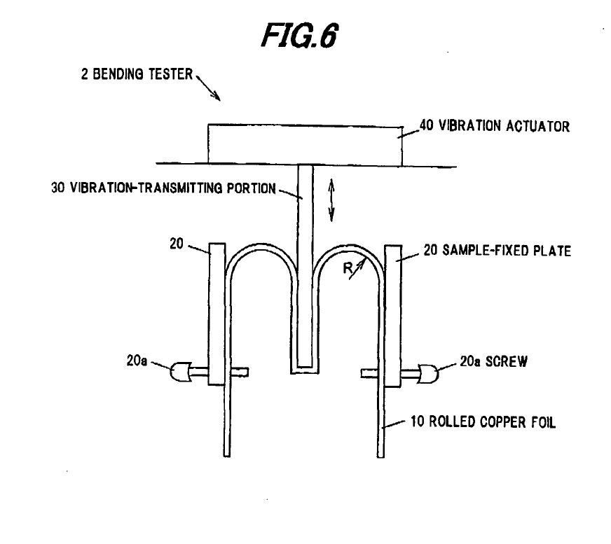

FIG. 6 is a schematic diagram showing a bending fatigue lifetime (sliding bending) testing method.

The bending fatigue lifetime testing is made, using a sliding bending tester (model: SEK-31B2S) Shin-Etsu Engineering Co., Ltd., conforming to IPC standards. Sliding bending tester 2 is equipped with sample-fixed plate 20 for holding rolled copper foil 10, screw 20a for fixing the rolled copper foil 10 to the sample-fixed plate 20, vibration-transmitting portion 30 for being contacted with the rolled copper foil 10 and transmitting vibration to the rolled copper foil 10, and vibration actuator 40 for vibrating vertically the vibration-transmitting portion 30.

Specifically, fabricating 12.7 mm-wide, 220 mm-long test pieces from the rolled copper foils (thickness 0.012 mm, i.e., 12 μm) in Examples 1-6 and comparative examples 1-6 respectively is followed by recrystallization annealing at 150° C. for 60 minutes of the test pieces. This is followed by bending fatigue lifetime testing. Also, fabricating 12.7 mm-wide, 220 mm-long test pieces from the rolled copper foils (thickness 0.012 mm, i.e., 12 μm) in Examples 1-6 and comparative examples 1-6 respectively is followed by recrystallization annealing at 350° C. for 60 minutes of the test pieces. This is likewise followed by bending fatigue lifetime testing.

The testing conditions for bending fatigue lifetime testing are as follows: the rolled copper foil curvature R is 1.5 mm; the amplitude stroke of the vibration-transmitting portion 30 is 10 mm; and the frequency of the vibration actuator 40 is 25 Hz (i.e., the amplitude velocity is 1500 times/min).

Also, the test piece 220 mm-length direction, i.e., the rolled copper foil 10 longitudinal direction is the rolling direction. Measurement is repeated 5 times for each sample, and the average values of the 5 measurements are compared. Its results are shown in Table 3.

TABLE 3

| | | Bending fatigue | Bending fatigue |
|---|---|---|---|
| | | lifetime property | lifetime property |
| | | [×10⁶ times] after | [×10⁶ times] after |
| | [a]/[b] | 150° C. × 60 min | 350° C. × 60 min |
| | by XRD | recrystallization | recrystallization |
| | pole figure | annealing | annealing |
| Example 1 | 3.1 | 1.8 | 1.7 |
| Example 2 | 4.5 | 2.0 | 2.1 |
| Example 3 | 3.5 | 1.8 | 1.8 |
| Example 4 | 3.6 | 2.0 | 1.9 |
| Example 5 | 3.7 | 1.9 | 2.0 |
| Example 6 | 4.5 | 2.1 | 2.2 |
| Comparative | 4.7 | 0.2 | 2.1 |
| example 1 | | | |
| Comparative | 3.5 | 1.8 | 0.9 |
| example 2 | | | |
| Comparative | 4.4 | 0.2 | 2.0 |
| example 3 | | | |
| Comparative | 3.5 | 0.2 | 1.3 |
| example 4 | | | |
| Comparative | 2.6 | 1.3 | 1.3 |
| example 5 | | | |
| Comparative | 2.2 | 0.8 | 0.8 |
| example 6 | | | |

Referring to Table 3, it is shown that the rolled copper foils in Examples 1-6 all exhibit excellent bending fatigue lifetimes of 1.8×10⁶ times to 2.2×10⁶ times in the wide temperature range from the low to high temperature condition, i.e., in both the low-temperature 150° C.×60 min and high-temperature 350° C.×60 min conditions.

On the other hand, the rolled copper foil in comparative example 1 contains 900 ppm of B, 8 ppm of O, but 700 ppm of Ag exceeding 0.05 wt. % (i.e., 500 ppm). Since the rolled copper foil in comparative example 1 contains excess Ag relative to Cu, the rolled copper foil in comparative example 1 is not softened in the low temperature condition (i.e., 150° C.×60 min), and therefore no bending fatigue lifetime enhancement by softening (i.e., recrystallization) is observed. Namely, the bending fatigue lifetime of the rolled copper foil in comparative example 1 is as low as 0.2×10⁶ times. It is noted, however, that the rolled copper foil in comparative example 1 is softened (i.e., recrystallized properly) at the high temperature (i.e., 350° C.×60 min), and therefore the high-temperature-treated rolled copper foil in comparative example 1 has the bending fatigue lifetime of 2.1×10⁶ times.

Also, the rolled copper foil in comparative example 2 contains 900 ppm of B, and 17 ppm of O. The addition of B has the effect of reducing the softening temperature of the rolled copper foil in comparative example 2 to 150° C.×60 min, thereby resulting in good bending fatigue lifetime properties. However, the amount of Ag is 30 ppm less than 0.005 wt. % (i.e., 50 ppm). Since the rolled copper foil in comparative example 2 contains insufficient Ag relative to Cu, the effect of Ag thereon is small in the high-temperature condition of 350° C.×60 min, in which the bending fatigue lifetime of the rolled copper foil in comparative example 2 is therefore deceased to half, compared to the case of 150° C.×60 min.

Next, the rolled copper foil in comparative example 3 contains 3 ppm of O, but 6 ppm of B, and 710 ppm of Ag. Since the rolled copper foil in comparative example 3 contains less B and more Ag than contained in any rolled copper foil in the Examples, the 150° C.×60 min thermal treatment of the rolled copper foil in comparative example 3 has no effect of B decreasing the softening temperature thereof, but only the excessive effect of Ag increasing the softening temperature. Consequently, the rolled copper foil is not softened (i.e., recrystallized), and the bending fatigue lifetime of the rolled copper foil in comparative example 3 is therefore not good. It is noted, however, that the rolled copper foil in comparative example 3, when treated in the high temperature condition of 350° C.×60 min, is properly softened (i.e., recrystallized) by Ag, and thereby has the good bending fatigue lifetime property.

Next, the rolled copper foil in comparative example 4 contains 5 ppm of O, but 7 ppm of B, and 30 ppm of Ag which are insufficient. Since the rolled copper foil in comparative example 4 contains less Ag which serves to increase the softening temperature, the 150° C.×60 min thermal treatment of the rolled copper foil in comparative example 4 is advantageous in softening thereof, compared to the rolled copper foil in comparative example 3. It is considered, however, that since the rolled copper foil in comparative example 4 contains insufficient B, the rolled copper foil in comparative example 4 has the softening properties analogous to the oxygen-free copper softening properties. Namely, the rolled copper foil in comparative example 4 is not softened in the low temperature condition of 150° C.×60 min, and has the decreased bending fatigue lifetime property in the high temperature condition of 350° C.×60 min due to less Ag, compared with the rolled copper foils in Examples 1-6. At 350° C., the rolled copper foil in comparative example 4 is fully but not properly softened (i.e., recrystallized) because 350° C. is higher than proper temperature. That is, within the temperature range of higher than 150° C. and lower than 350° C., the rolled copper foil in comparative example 4 has proper values, and therefore exhibits the good bending fatigue lifetime properties, but the bending fatigue lifetime properties at 150° C. and 350° C. are less than the minimum value, and more than the maximum value respectively of the proper range.

Next, the rolled copper foil in comparative example 5 contains 370 ppm of B, 2 ppm of O, and 190 ppm of Ag. Here, in the rolled copper foil in comparative example 5, the bending fatigue lifetime property after thermal treatment in the high temperature condition of 350° C.×60 min is not decreased, relative to the bending fatigue lifetime property after thermal treatment in the high temperature condition of 150° C.×60 min. On the other hand, the [a]/[b] value computed from X-ray diffraction pole figure measurement after final rolling is 2.6 smaller than 3. Accordingly, the bending fatigue lifetime properties of the rolled copper foil in comparative example 5 are on the order of 60%-70% of the bending fatigue lifetime properties of the rolled copper foils in Examples 1-6.

Next, the rolled copper foil in comparative example 6 contains 250 ppm of B, 8 ppm of O, and 300 ppm of Ag. Here, in the rolled copper foil in comparative example 6, the bending fatigue lifetime property after thermal treatment in the high temperature condition of 350° C.×60 min is not decreased, relative to the bending fatigue lifetime property after thermal treatment in the high temperature condition of 150° C.×60 min. On the other hand, the [a]/[b] value computed from X-ray diffraction pole figure measurement after final rolling is 2.2 smaller than 3. It is shown that the [a]/[b] value in comparative example 6 is even smaller than the [a]/[b] value in comparative example 5. Accordingly, the bending fatigue lifetime properties of the rolled copper foil in comparative example 6 are around 40% (specifically, on the order of 36%-44%) of the bending fatigue lifetime properties of the rolled copper foils in Examples 1-6.

### Modification 1 to the Examples

A rolled copper foil in modification 1 to the Examples 1-6 is produced by adding to oxygen-free copper, niobium (Nb), titanium (Ti), nickel (Ni), zirconium (Zr), vanadium (V), manganese (Mn), hafnium (Hf), tantalum (Ta), or calcium (Ca), instead of B. The additive amount is not less than 0.001 wt. % and not more than 0.09 wt. %. For example, a rolled copper foil in modification 1 to the Examples is added with 0.003 wt. % of Ti, instead of B, thereby having excellent bending fatigue lifetime properties, similar to the bending fatigue lifetime properties of the rolled copper foils in Examples 1-6.

### Modification 2 to the Examples

A rolled copper foil in modification 2 to the Examples 1-6 is produced by adding to oxygen-free copper, plural elements selected from the group consisting of niobium (Nb), titanium (Ti), nickel (Ni), zirconium (Zr), vanadium (V), manganese (Mn), hafnium (Hf), tantalum (Ta), or calcium (Ca), instead of B. The additive amount is not less than 0.001 wt. % and not more than 0.09 wt. %. For example, a rolled copper foil in modification 2 to the Examples is added with 0.01 wt. % of Ni, and 0.002 wt. % of Ti, instead of B, and another rolled copper foil in modification 2 to the Examples is added with 0.005 wt. % of B, and 0.005 wt. % of Mn, thereby having excellent bending fatigue lifetime properties, similar to the bending fatigue lifetime properties of the rolled copper foils in Examples 1-6.

Although the invention has been described with respect to the above embodiments, the above embodiments are not intended to limit the appended claims. Also, it should be noted that not all the combinations of the features described in the above embodiments are essential to the means for solving the problems of the invention.

What is claimed is:

1. A rolled copper foil, comprising:
copper (Cu);
an inevitable impurity,
a first additive element that forms a solid solution in the copper; and
a second additive element that is different from the first additive element, is contained in the copper, and forms a compound with the inevitable impurity.

2. The rolled copper foil according to claim 1, further comprising not more than 0.002 wt. % of oxygen.

3. The rolled copper foil according to claim 1, wherein
the first additive element comprises not less than 0.005 wt. % and not more than 0.05 wt. % of silver (Ag).

4. The rolled copper foil according to claim 2, wherein
the first additive element comprises not less than 0.005 wt. % and not more than 0.05 wt. % of silver (Ag).

5. The rolled copper foil according to claim 1, wherein
the second additive element comprises not less than 0.001 wt. % and not more than 0.09 wt. % of boron (B).

6. The rolled copper foil according to claim 4, wherein
the second additive element comprises not less than 0.001 wt. % and not more than 0.09 wt. % of boron (B).

7. The rolled copper foil according to claim 3, wherein
the second additive element comprises one element selected from the group consisting of niobium (Nb), titanium (Ti), nickel (Ni), zirconium (Zr), vanadium (V), manganese (Mn), hafnium (HO, tantalum (Ta), and calcium (Ca), and a content thereof is not less than 0.001 wt. % and not more than 0.09 wt. %.

8. The rolled copper foil according to claim 3, wherein
the second additive element comprises a plurality of elements selected from boron (B), niobium (Nb), titanium (Ti), nickel (Ni), zirconium (Zr), vanadium (V), manganese (Mn), hafnium (Hf), tantalum (Ta), and calcium (Ca), and a total content thereof is not less than 0.001 wt. % and not more than 0.09 wt. %.

9. The rolled copper foil according to claim 1, wherein
the rolled copper foil is formed to be in a crystal grain orientation state in which, as a result obtained by pole figure measurement using X-ray diffraction taking rolled surface as a reference point, the ratio [a]/[b] of β-scanning average diffraction peak intensities [a] at α=90° and [b] at α=30° of the pole figure measurement of a {022}_{Cu} copper crystal plane is [a]/[b]≧3.

10. The rolled copper foil according to claim 1, wherein
the rolled copper foil comprises a thickness of not more than 20 μm.
